(19) United States
(12) Patent Application Publication
(10) Pub. No.: US 2018/0122217 A1
(43) Pub. Date: May 3, 2018

(54) Detecting Wireless Signals to Engage Security System Awareness

(71) Applicant: Lenovo (Singapore) Pte. Ltd., Singapore (SG)

(72) Inventors: John C. Mese, Cary, NC (US); Nathan J. Peterson, Oxford, NC (US); Russell S. VanBlon, Raleigh, NC (US); Rod D. Waltermann, Rougemont, NC (US); Arnold S. Weksler, Raleigh, NC (US)

(21) Appl. No.: 15/336,100

(22) Filed: Oct. 27, 2016

(51) Int. Cl. G08B 25/00; G08B 25/10

(52) U.S. Cl. CPC G08B 25/008; G08B 25/10

(57) ABSTRACT

An approach is disclosed that detects a wireless fingerprint. A security action is determined in response to the detection. The determined security action is then performed by the security system.

### BACKGROUND

Security systems mostly rely on either being on all the time, or at the right time. They also rely on physical data. Camera systems also tend to either be on all the time, or depend on a motion sensor. Cameras generally also have rolling video where the oldest data is deleted and replaced by newer video data. Security systems have not changed very much in many years. While there have been slight improvements in enabling remote control access, adding more cameras, and use of geo-fencing options for enabling the security system, fundamental improvements have not been made to traditional security systems.

### SUMMARY

An approach is disclosed that detects a wireless fingerprint. A security action is determined in response to the detection. The determined security action is then performed by the security system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting a security system that monitors wireless fingerprints emitting from wireless devices as well as human signatures detected by proximity sensors;

FIG. 4 is a flowchart showing steps performed to setup the security system that monitors wireless fingerprints emitting from wireless devices as well as human signatures detected by proximity sensors;

FIG. 5 is a flowchart showing steps performed to monitor signals emitted from wireless devices as well as human signatures detected by proximity sensors; and

FIG. 6 is a flowchart showing steps that perform security actions based data pertaining to detected wireless devices as well as for human signatures detected to not be emitting wireless fingerprint signals.

### DETAILED DESCRIPTION

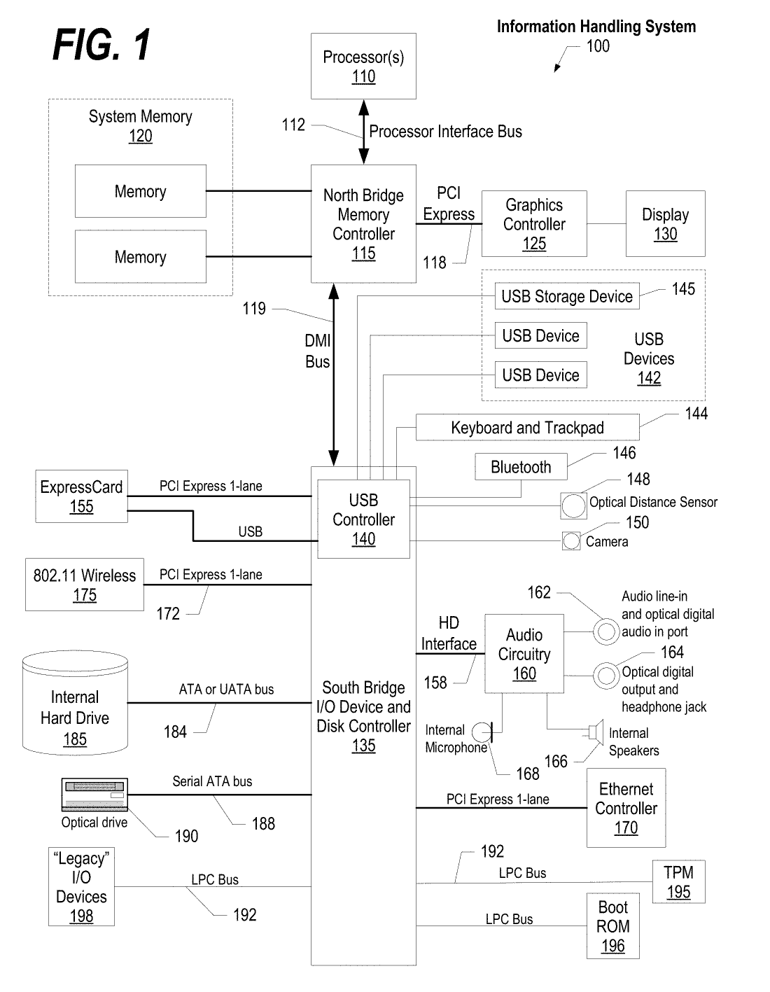

An approach is depicted in FIGS. 1-6 that detects wireless signals to engage security system awareness. Using detected wireless signals, this approach makes an alarm system smarter. The approach involves storing a user's personal wireless fingerprints in a security system via a router or other means. This would include all of the system's Wi-Fi signals, Bluetooth, NFC, etc. When the system detects a wireless signal that doesn't belong to a member of the household, the approach can modify parameters of the security system. For example, the approach could turn on the security system if it was turned off, turn on the security cameras and/or permanently store the camera feeds, etc. for future reference.

The following examples are provided for further illustration of the approach depicted herein. In a first example, a user's wireless fingerprints are stored as know users to the system. Any other wireless fingerprints signals would set parameters on the security system (e.g., turn system ON, turn cameras ON, etc.). In a second example, a stranger's wireless fingerprints are logged as well and then added to the list of know users, as needed. Visiting friends, relatives, etc. can be added to the list. In a third example involving a populated area, the approach can limit the range of detection to not pick up neighbors' houses, etc. The approach can also go through a learning mode if necessary to detect constant wireless signals from a neighbor's house. Security system parameters could then be triggered also by an increasing signal strength of a neighbor's device in case the neighbors are walking to the user's house rather than just staying at their house. A fourth example, set in a rural area, the approach does not have to perform any learning that might otherwise be performed in a populated area.

The following are few use cases that further illustrate the approach described herein. In a first use case, someone comes to the user's house in the middle of the day, in which case the user's security system could arm itself the user had forgotten to arm the system when the user left the house to go to work. The approach could also send the user an alert that the system detected unknown wireless signals proximate to the user's home along with the types of signals and potentially a signal strength. As wireless technology advances, the signal strengths and data associated will provide better distance metrics. In a second use case, if an unknown person comes to the user's house, it could turn on the user's security cameras even before the motion sensors detect anyone near the premises. In addition, the approch could send the user an alert of an outside presence near the user's home. In a third use case, if a family member visits the user's home, the security system can detect the visit and the user can opt to add the family member's wireless fingerprint to a list of know users along with the identification of the family member being added to the list.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

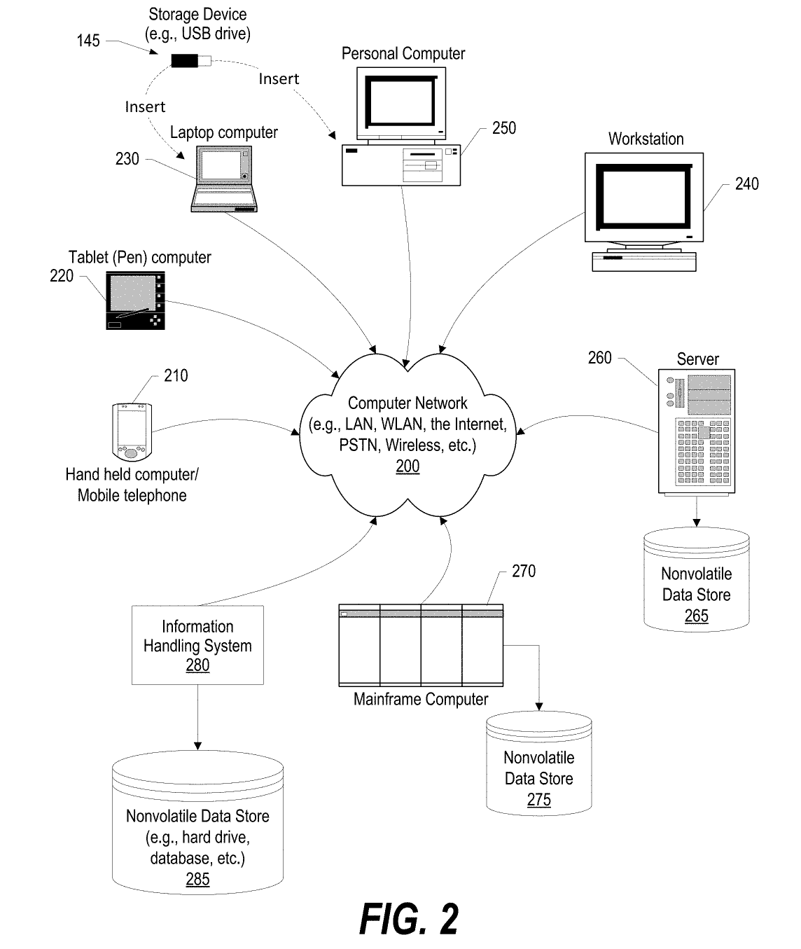

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119.

In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include digital camera 150, optical distance sensor 148, keyboard and trackpad 144, and Bluetooth device 146, which provides for wireless personal area networks (PANs). Optical distance sensor 148 can detect the distance from a device to various objects, such as users of the system, while digital camera 150 can be used to capture images of objects, such as users of the system, to enable recognition software, such as facial recognition software, to identify the users of the system. USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

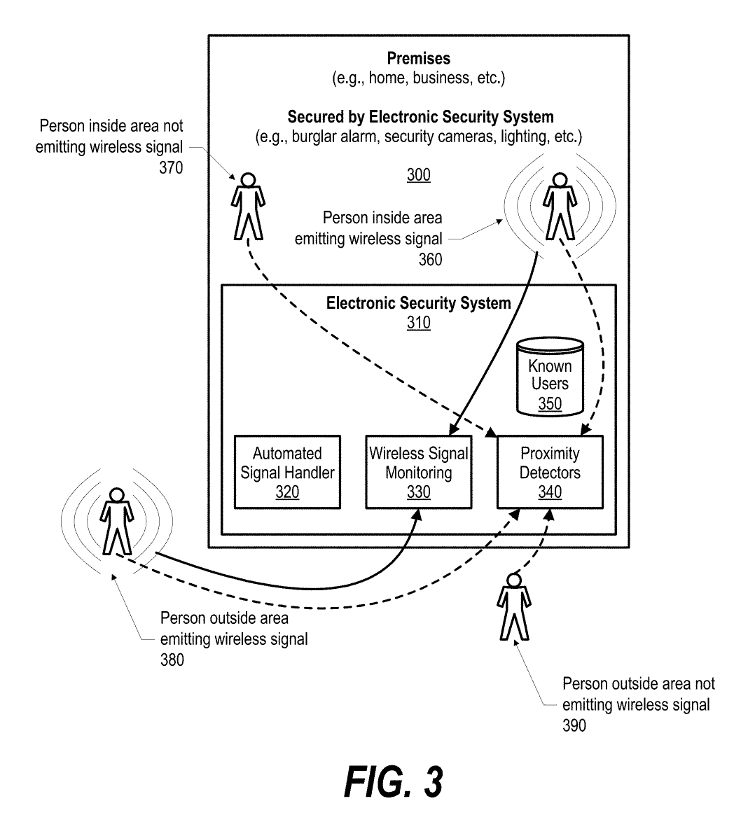

FIG. 3 is a diagram depicting a security system that monitors wireless fingerprints emitting from wireless devices as well as human signatures detected by proximity sensors. FIG. 3 depicts premises 300, such as a home, business or the like, that is a physical location that is protected by electronic security system 310.

Electronic security system 310 monitors an area within and proximate to premises 300 using a variety of means. Automated signal handler 320 is a process that performs security actions, such as activating the security system, turning on a security camera, turning on security lights, sending a security notification, sounding an audible alarm, activating a silent alarm, notifying law enforcement, and the like. Automated signal handler 320 uses data collected by wireless signal monitoring process 330 that monitors the area proximate and within the premises for wireless security signals, such as MAC addresses, that act as wireless fingerprints for wireless devices, such as smart phones, tablet computer systems, laptop computer systems, and other electronic devices, especially portable electronic devices.

Automated security handler process 320 further receives data from proximity detectors 340 that sense the proximity of people (human signatures) in and about the premises. Known users 350 is a data store that has a lists of known users with such users' wireless fingerprints. Automated signal handler 320 identifies users in and about premises 300 and based on the identity of the user, as well as additional factors such as the timestamp (day of year, day of week, time of day, etc.) and the location of the user (inside the premises or outside the premises) to determine what, if any, security action should be performed. A wireless fingerprint that does not correspond to a user is also handled by the automated signal handler. The wireless fingerprint can be used to update the list of known users and stored in data store 350 or, if the wireless fingerprint corresponds with an unknown person, the automated signal handler can perform other security actions (e.g., arm the security system, turn on the security cameras, notify one or more individuals about the presence of the user, etc.). Different security actions can be taken based on other factors, such as whether the wireless fingerprint is located at a device within the premises or outside the premises, and the time of day at which the wireless fingerprint is detected (e.g., a wireless fingerprint emitted from a mobile phone of a person that is approaching the premises during the middle of the night can cause a security action different from the same fingerprint being detected during the middle of the day, etc.). Finally, automated signal handler can perform security actions due to detection of a person, such as persons 370 and 390, that are not emitting wireless fingerprint information but detected by the security system's proximity detectors 340.

The detection of different people in different locations can cause performance of different security actions. As shown, user 360 has been detected within premises 300 and has been found to be emitting a wireless fingerprint. On the other hand, user 370 has been detected by the proximity detectors as being within the premises as well, however user 370 is not emitting a wireless fingerprint. User 380 has been detected outside of premises 300 and has been found to be emitting a wireless fingerprint, while user 390 has also been detected by the proximity detectors as being outside the premises, however user 390 is not emitting a wireless fingerprint.

For simplicity, in the diagrams each user is shown to correspond either no wireless fingerprints or to a single wireless fingerprint. In actual practice, each wireless device, such as a smart phone, might be capable of emitting several wireless fingerprints, such as a WiFi fingerprint, a cellular (e.g., 3G, 4G, etc.) wireless fingerprint, a Bluetooth wireless fingerprint, and possibly other wireless fingerprints. In addition, each user can carry multiple wireless devices, with each of which emitting multiple wireless fingerprints.

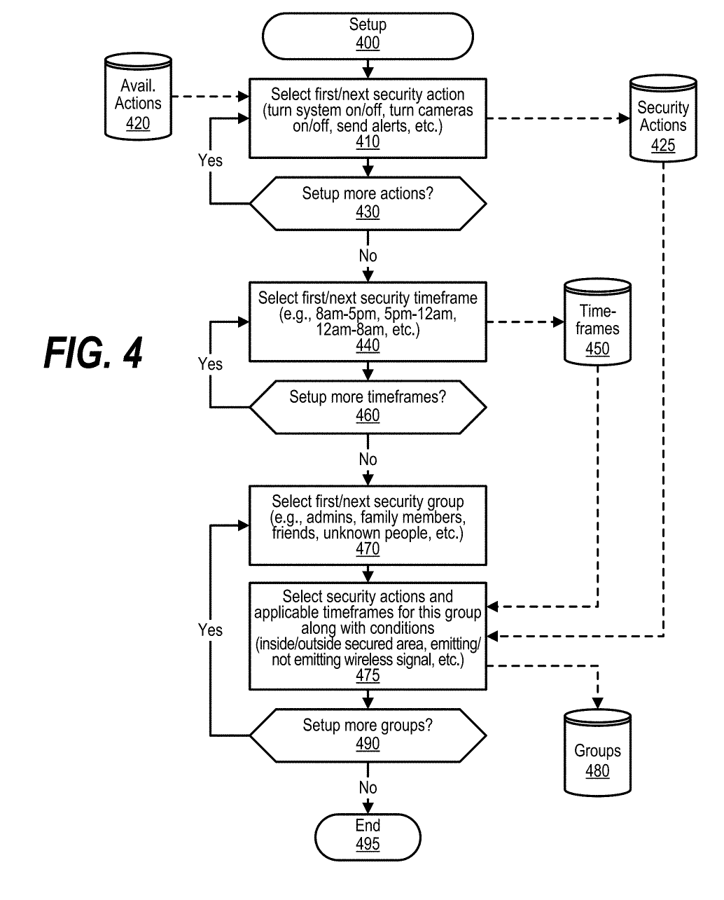

FIG. 4 is a flowchart showing steps performed to setup the security system that monitors wireless fingerprints emitting from wireless devices as well as human signatures detected by proximity sensors. FIG. 4 processing commences at 400 and shows the steps taken by a process that sets up security actions and other security data used by a security system that monitors and acts on wireless fingerprint data. At step 410, the process selects the first security action from a list of available security actions (data store 420) and stores the selected security actions in data store 425. Security actions might include activating the security system, turning on a security camera, turning on security lights, sending a security notification, sounding an audible alarm, activating a silent alarm, notifying law enforcement, and the like. The process determines as to whether the user setting up the system desires to set up additional security actions (decision 430). If the user setting up the system desires to set up additional security actions, then decision 430 branches to the ‘yes’ branch which loops back to step 410 to set up the next security action. This looping continues until the user setting up the system does not which to set up any more security actions, at which point decision 430 branches to the ‘no’ branch exiting the loop.

At step 440, the user setting up the security actions selects the first security timeframe to use. For example, a set of timeframes might include 8 am-5 pm, 5 pm-12 am, 12 am-8 am, etc. The timeframes setup by the user are stored in data store 450. The process determines as to whether the user wants to set up more timeframes (decision 460). If the user wants to set up more timeframes, then decision 460 branches to the ‘yes’ branch which loops back to step 440 to set up the next timeframe. This looping continues until all of the timeframes have been setup, at which point decision 460 branches to the ‘no’ branch exiting the loop.

At step 470, the user selects the first security group. Examples of security groups might include admins, family members, friends, unknown people (strangers), etc. Unknown people is a group of people with wireless fingerprints that are unknown to the system. This group can be used to set up security actions that should occur when an unknown person is detected by the security system. At step 475, the process selects the security actions and any applicable timeframes for this group along with conditions that will be checked by the security system (e.g., whether the user is inside or outside the premises, whether the user is emitting a wireless fingerprint, etc.). The group data is stored in data store 480. The process determines as to whether the user wants to setup additional security groups (decision 490). If the user wants to setup additional security groups, then decision 490 branches to the ‘yes’ branch which loops back to step 470 to setup the next security group. This looping continues until the user does not want to setup any more security groups, at which point decision 490 branches to the ‘no’ branch exiting the loop. FIG. 4 processing thereafter ends at 495.

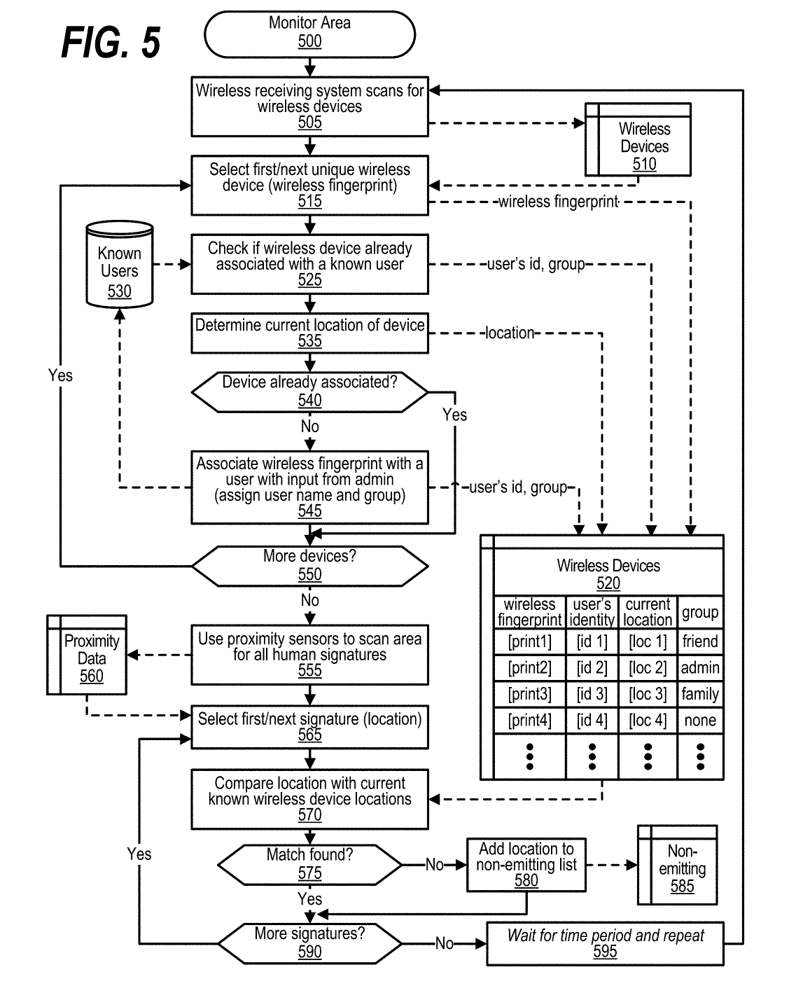

FIG. 5 is a flowchart showing steps performed to monitor signals emitted from wireless devices as well as human signatures detected by proximity sensors. FIG. 5 processing commences at 500 and shows the steps taken by a process that monitors the area in and near a premises that is being secured. At step 505, the process uses its wireless receiving system(s) to scan the area in and near the premises for any wireless fingerprints emitted by wireless devices. These wireless fingerprints are stored in memory area 510.

At step 515, the process selects the first unique wireless fingerprint from data store 510. The wireless fingerprint is used to create an entry in table 520 that lists the currently detected wireless fingerprints in the area. At step 525, the process checks to see if this wireless fingerprint has already been associated with a known user by comparing the selected wireless fingerprint to the wireless fingerprints stored in data store 530. Data retrieved from data store 530, such as the user's name and security group, are added to table 520. At step 535, the process determines current location of device based on the location of the source from which the wireless fingerprint is being emitted. The location data for the wireless fingerprint is also added to table 520.

The process determines as to whether this wireless fingerprint has already been associated with a user (decision 540). If this wireless fingerprint has already been associated with a user, then decision 540 branches to the ‘yes’ branch bypassing step 545. On the other hand, if this wireless fingerprint has not already been associated with a user, then decision 540 branches to the ‘no’ branch to perform step 545. At step 545, the process associates the wireless fingerprint with a user with input from the admin of the security system. The admin can assign the user a name and also assign the user to a security group. If the admin does not know who the wireless fingerprint belongs to, such as an intruder or other unknown person, then the admin does not assign the wireless fingerprint to a user name and the wireless fingerprint is automatically associated with the “unknown” security group. Any data provided by the admin is added to table 520.

The process determines as to whether there more wireless fingerprints to process (decision 550). If there more wireless fingerprints to process, then decision 550 branches to the ‘yes’ branch which loops back to step 515 to select and process the next wireless fingerprint as described above. This looping continues until there are no more wireless fingerprints to process, at which point decision 550 branches to the ‘no’ branch exiting the loop.

At step 555, the process uses proximity sensors to scan area for all human signatures. Hits of locations where human signatures have been detected by the proximity sensors are stored in memory area 560. At step 565, the process selects the first location where a human signature was found from memory area 560. At step 570, the process compares the location found with the proximity sensors with current known wireless device locations.

The process determines as to whether the human signature was matched to a location of one of the known wireless devices (decision 575). If a match was found, then decision 575 branches to the ‘yes’ branch bypassing step 580. On the other hand, if not match found, then decision 575 branches to the ‘no’ branch to perform step 580. At step 580, the process adds the location detected by the proximity sensors to the non-emitting list (memory area 585) The process determines as to whether there are more human signatures detected by the proximity sensors (decision 590). If there are more human signatures detected by the proximity sensors, then decision 590 branches to the ‘yes’ branch which loops back to step 565 to select and process the next location from memory area 580. This looping continues until all of the locations have been processed, at which point decision 590 branches to the ‘no’ branch exiting the loop. At step 595, the process waits for a given time period to elapse (e.g., one minute, etc.) and processing loops back to step 505 to repeat the process.

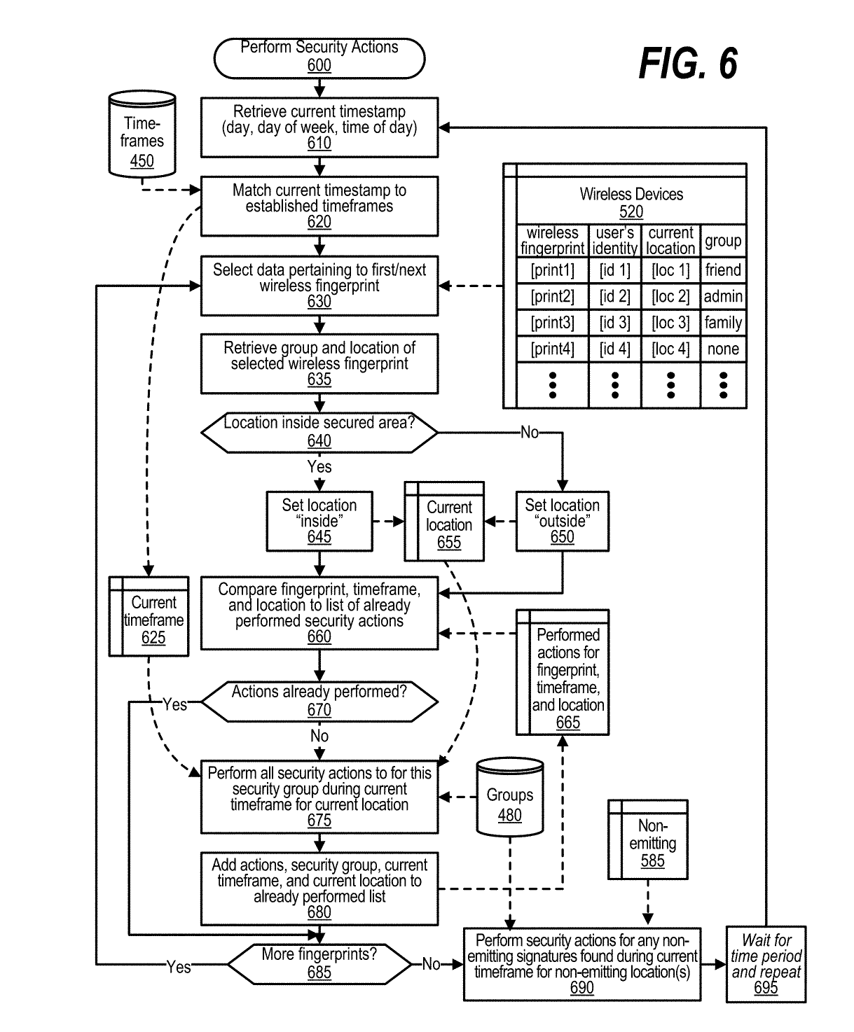

FIG. 6 is a flowchart showing steps that perform security actions based data pertaining to detected wireless devices as well as for human signatures detected to not be emitting wireless fingerprint signals. The process performed in FIG. 6 uses Table 520 that was generated by the processing shown in FIG. 5 as an input. FIG. 6 processing commences at 600 and shows the steps taken by a process that performs security actions. At step 610, the process retrieves the current timestamp (day, day of week, time of day) from the computer system. At step 620, the process matches the current timestamp to the established timeframes that are retrieved from data store 450 to identify the current timeframe, with the current timeframe being stored in memory area 625.

At step 630, the process selects data pertaining to the first wireless fingerprint with the data being retrieved from table 520. At step 635, the process retrieves the group and the location of the selected wireless fingerprint from the data that was retrieved from table 520. The process determines as to whether the location of the selected wireless fingerprint is inside the premises (decision 640). If the location of the selected wireless fingerprint is inside the premises, then decision 640 branches to the ‘yes’ branch whereupon, at step 645, the current location is set to “inside” and this location data is stored in memory area 655. On the other hand, if the location of the selected wireless fingerprint is outside the premises, then decision 640 branches to the ‘no’ branch whereupon, at step 650, the current location is set to “outside” and this location data is stored in memory area 655.

At step 660, the process compares the retrieved wireless fingerprint, the current timeframe from memory area 625, and the current location from memory area 655 to a list of security actions that have already been performed with data pertaining to previously performed security actions being retrieved from memory area 665. The process determines as to whether the security actions have already been performed (decision 670). If the security actions have already been performed, then decision 670 branches to the ‘yes’ branch bypassing steps 675 and 680. On the other hand, if the security actions have not already been performed, then decision 670 branches to the ‘no’ branch to perform steps 675 and 680.

At step 675, the process performs all security actions to for this security group during current timeframe for current location. This list of security actions to perform is retrieved from group data store 480 and is found by matching the group of this wireless fingerprint with the current timeframe and current location data. At step 680, the process adds the actions performed, the security group, the current timeframe, and the current location to the already performed list that is stored in memory area 665.

The process determines as to whether there are more wireless fingerprint to process (decision 685). If there are more wireless fingerprint to process, then decision 685 branches to the ‘yes’ branch which loops back to step 630 to select and process the next wireless fingerprint from table 520 as described above. This looping continues until there are no more wireless fingerprint to process, at which point decision 685 branches to the ‘no’ branch exiting the loop.

At step 690, the process performs any security actions that have been established to be performed for any non-emitting human signatures found during current timeframe for non-emitting location(s). Non-emitting signatures are locations where a human signature was found but not matching a location where a wireless fingerprint was found. This list of non-emitting signatures is retrieved from memory area 585 and the security actions to perform are retrieved from group data store 480 (e.g., a group called “non-emitting,” etc.). At step 695, the process waits for a time period to elapse (e.g., one minute, etc.) and then processing loops back to step 610 to repeat the process.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method comprising:
detecting a wireless fingerprint;
selecting a security action to perform at a security system in response to the detection; and
performing the selected security action at the security system.

2. The method of claim 1 further comprising:
further selecting the security action from a plurality of security actions, wherein the plurality of security actions comprise one or more of activating the security system, turning on a security camera, turning on security lights, sending a security notification, sounding an audible alarm, activating a silent alarm, and notifying law enforcement.

3. The method of claim 1 further comprising:
detecting a current location corresponding to the detected wireless fingerprint; and
retrieving a current time, wherein the selection of the security action is further based on the detected current location and the current time.

4. The method of claim 1 further comprising:
comparing the detected wireless fingerprint to a plurality of stored wireless fingerprints, wherein each of the stored wireless fingerprints correspond to at least one user, and wherein the selection of the security action is further based on the comparison; and
retrieving a predefined security action that corresponds to a selected user, wherein the selected user is identified based on the comparison, and wherein the retrieved predefined security action is the selected security action.

5. The method of claim 1 further comprising:
comparing the detected wireless fingerprint to a plurality of stored wireless fingerprints, wherein each of the stored wireless fingerprints correspond to at least one user, and wherein the comparison results in an identified user;
detecting a current location corresponding to the detected wireless fingerprint; and
retrieving a current time, wherein the selection of the security action is based on the detected current location, the current time, and the identified user.

6. The method of claim 1 further comprising:
comparing the detected wireless fingerprint to a plurality of stored wireless fingerprints, wherein each of the stored wireless fingerprints correspond to at least one user, and wherein the comparison fails to identify a user that corresponds to the detected wireless fingerprint, wherein the security action is based on the failure to identify the user corresponding to the detected wireless fingerprint.

7. The method of claim 1 wherein the detected wireless fingerprint is one of a plurality of wireless fingerprints that have been detected within a current timeframe, wherein the method further comprises:
identifying a geographical location corresponding to each of the plurality of wireless fingerprints;
detecting a human signature using a proximity detector, wherein the human signature is identified at being at another geographical location that does not match any of the identified geographical locations; selecting a second security action to perform at a security system in response to the detection of a human signature that does not correspond with a wireless fingerprint; and
performing the selected second security action at the security system.

8. An information handling system comprising:
one or more processors;
a display screen accessible by at least one of the processors;
a sensor, accessible by at least one of the processors, that senses and receives wireless fingerprint signals;
a memory coupled to at least one of the processors; and
a set of instructions stored in the memory and executed by at least one of the processors to perform actions comprising:
detect a wireless fingerprint;
determine a security action to perform at the information handling system in response to the detection; and
perform the determined security action by the information handling system.

9. The information handling system of claim 8 wherein the actions further comprise:
further select the security action from a plurality of security actions, wherein the plurality of security actions comprise one or more of actions to activate the security system, turn on a security camera, turn on security lights, send a security notification, sound an audible alarm, activate a silent alarm, and notify law enforcement.

10. The information handling system of claim 8 wherein the actions further comprise:
detect a current location corresponding to the detected wireless fingerprint; and
retrieve a current time, wherein the selection of the security action is further based on the detected current location and the current time.

11. The information handling system of claim 8 wherein the actions further comprise:
compare the detected wireless fingerprint to a plurality of stored wireless fingerprints, wherein each of the stored wireless fingerprints correspond to at least one user, and wherein the selection of the security action is further based on the comparison; and
retrieve a predefined security action that corresponds to a selected user, wherein the selected user is identified based on the comparison, and wherein the retrieved predefined security action is the selected security action.

12. The information handling system of claim 8 wherein the actions further comprise:
compare the detected wireless fingerprint to a plurality of stored wireless fingerprints, wherein each of the stored wireless fingerprints correspond to at least one user, and wherein the comparison results in an identified user;
detect a current location corresponding to the detected wireless fingerprint; and
retrieve a current time, wherein the selection of the security action is based on the detected current location, the current time, and the identified user.

13. The information handling system of claim 8 wherein the actions further comprise:
compare the detected wireless fingerprint to a plurality of stored wireless fingerprints, wherein each of the stored wireless fingerprints correspond to at least one user, and wherein the comparison fails to identify a user that corresponds to the detected wireless fingerprint, wherein the security action is based on the failure to identify the user corresponding to the detected wireless fingerprint.

14. The information handling system of claim 8 wherein the detected wireless fingerprint is one of a plurality of wireless fingerprints that have been detected within a current timeframe, wherein the actions further comprise:
identify a geographical location corresponding to each of the plurality of wireless fingerprints;
detect a human signature using a proximity detector, wherein the human signature is identified at being at another geographical location that does not match any of the identified geographical locations;
select a second security action to perform at a security system in response to the detection of a human signature that does not correspond with a wireless fingerprint; and
perform the selected second security action at the security system.

15. A computer program product comprising:
a computer readable storage medium comprising a set of computer instructions, the computer instructions effective to:
detect a wireless fingerprint;
determine a security action to perform at a security system in response to the detection; and
perform the determined security action by the security system.

16. The computer program product of claim 15 wherein the computer instructions are further effective to:
detect a current location corresponding to the detected wireless fingerprint; and
retrieve a current time, wherein the selection of the security action is further based on the detected current location and the current time.

17. The computer program product of claim 15 wherein the computer instructions are further effective to:
compare the detected wireless fingerprint to a plurality of stored wireless fingerprints, wherein each of the stored wireless fingerprints correspond to at least one user, and wherein the selection of the security action is further based on the comparison; and
retrieve a predefined security action that corresponds to a selected user, wherein the selected user is identified based on the comparison, and wherein the retrieved predefined security action is the selected security action.

18. The computer program product of claim 15 wherein the computer instructions are further effective to:
compare the detected wireless fingerprint to a plurality of stored wireless fingerprints, wherein each of the stored wireless fingerprints correspond to at least one user, and wherein the comparison results in an identified user;
detect a current location corresponding to the detected wireless fingerprint; and
retrieve a current time, wherein the selection of the security action is based on the detected current location, the current time, and the identified user.

19. The computer program product of claim 15 wherein the computer instructions are further effective to:
compare the detected wireless fingerprint to a plurality of stored wireless fingerprints, wherein each of the stored wireless fingerprints correspond to at least one user, and wherein the comparison fails to identify a user that corresponds to the detected wireless fingerprint, wherein the security action is based on the failure to identify the user corresponding to the detected wireless fingerprint.

20. The computer program product of claim 15 wherein the detected wireless fingerprint is one of a plurality of wireless fingerprints that have been detected within a current timeframe, wherein the computer instructions are further effective to:
identify a geographical location corresponding to each of the plurality of wireless fingerprints;
detect a human signature using a proximity detector, wherein the human signature is identified at being at another geographical location that does not match any of the identified geographical locations;
select a second security action to perform at a security system in response to the detection of a human signature that does not correspond with a wireless fingerprint; and
perform the selected second security action at the security system.
